(19) United States
(12) Patent Application Publication
(10) Pub. No.: US 2007/0154610 A1
(43) Pub. Date: Jul. 5, 2007

(54) Lemon ice confection

(76) Inventor: Robert E. Jones, Bailey, CO (US)

Correspondence Address: BARBER LEGAL, P.O. BOX 16220, GOLDEN, CO, 80402-6004, US

(21) Appl. No.: 11/323,083

(22) Filed: Dec. 30, 2005

(51) Int. Cl. A23G 9/00

(52) U.S. Cl. 426/565

(57) ABSTRACT

The present invention teaches an easy to make and low cost lemon ice dessert and a method of making by carefully controlling boiling times and temperatures so as to maintain a natural lemon savor in a straightforward combination of sugar, lemon product and water. The mixture of lemon extracted fluids, sugar and water provides an all-natural frozen ice confection of unusual consistency and flavor with easy manufacture.

### FIELD OF THE INVENTION

This invention relates generally to ice confections devices and specifically to an improved ice confection and process.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

Most ice confections are either made by complex processes that provide an ice cream type confection but increase cost of manufacture. On the other hand, frozen confections made by direct freezing processes tend to be extremely hard, with the consistency of an ice cube.

US Statutory Invention Registration No. H847 in the name of White et al and published Nov. 6, 1990, METHODS OF USING CRYSTALLINE FRUCTOSE, teaches methods of using sugar, but does not directly relate to lemon ice making.

U.S. Pat. No. 6,824,808 issued Nov. 30, 2004 in the name of Best et al for CHEWY CANDY ANALOGUE, METHOD OF MAKING, AND COMPOSITE ICE CONFECTIONS CONTAINING SAME also does not teach important steps of making the lemon ice confection of the invention, and in fact teaches away from the present invention by teaching towards more complex multi-component confections of ice cream and chewy candy.

U.S. Pat. No. 6,162,789 issued Dec. 19, 2000 in the name of Lillford et al for FROZEN FOOD PRODUCT and U.S. Pat. No. 6,156,880 issued Dec. 5, 2000 and U.S. Pat. No. 6,090,917 issued Jul. 18, 2000 to the same inventor and having the same title, teach a method of isolating anti-freeze proteins for frozen food products. No specific recipe for a lemon ice product is provided.

U.S. Pat. No. 5,645,881 issued Jul. 8, 1991 in the name of Tancibok et al for REDUCED CALORIE ICE CREAM-TYPE FROZEN DESSERT AND BUTTER FAT MIMETICS THEREFOR is another item directed towards the teaching of specific components of a dessert and the desserts possible therewith, rather than with a specific recipe for a lemon ice dessert.

U.S. Pat. No. 3,726,693 issued Apr. 10, 1973 to Norman E. Harris and entitled DEHYDRATED FOOD COATED WITH EDIBLE OIL, GELATIN, GLYCERIN AQUEOUS EMULSION teaches another technical component of a dessert rather than a lemon ice.

U.S. Pat. No. 3,471,301 issued Oct. 7, 1969 to William A. Mitchell for DESSERT-ON-THE-STICK is another gelatin related dessert item.

U.S. Pat. No. 2,801,922 issued Aug. 6, 1957 to Sabin Oprean for FROZEN CONFECTION teaches a frozen dessert of various oils and colors, rather than a mixture of lemon products frozen.

U.S. Pat. No. 2,279,203 issued Apr. 7, 1942 to Albert Musher for ICE CREAM MIXTURE teaches a butter coated corn flake mixture with ice cream. The making of a lemon ice dessert is not mentioned.

U.S. Pat. No. 2,182,784 issued Dec. 12, 1939 to A. H. Bayer for FROZEN CONFECTIONARY PRODUCT AND METHOD OF MAKING THE SAME teaches a multilayered confection on a stick and apparatus used to make it.

U.S. Pat. No. 2,133,586 issued Oct. 13, 1938 to Otto C. Stanger and Alva Thompson for FROZEN CONFECTION, COATING COMPOUND THEREFORE, AND PROCESS OF MAKING COATING COMPOUND is principally directed towards a layer of a multilayer confection of sugar, corn syrup, and other ingredients not apparently directed towards lemon ingredient desserts.

U.S. Pat. No. 1,404,539 issued Jan. 24, 1922 to C. K. Nelson for CONFECTION teaches a brick style dessert having solid base of cracker or cookie and a wrapping of an edible chocolate candy type. Details of the formulation of the sherbert or ice cream within are not discussed.

None of these teach an easy to make and low cost lemon ice dessert.

None of these teach an easy manufacturing process for a lemon ice dessert which has a texture dissimilar to solid ice, but also dissimilar to ice cream.

### SUMMARY OF THE INVENTION

General Summary

The present invention teaches an easy to make and low cost lemon ice dessert and a method of making by carefully controlling boiling times and temperatures so as to maintain a natural lemon savor in a straightforward combination of sugar, lemon product and water. The mixture of lemon extracted fluids, sugar and water provides an all-natural frozen ice confection of unusual consistency and flavor with easy manufacture.

Summary in Reference to Claims

It is therefore a first aspect, advantage, objective and embodiment of the invention to provide a method of preparing an improved lemon ice confection, the method comprising the steps of:
a) providing a first quantity of water in a first container;
b) providing a source of heat sufficient to boil the water;
c) adding to the water 2 cups of sugar per quart of water while continuing to boil the water;
d) continuing to boil the water until the sugar dissolves;
e) removing the source of heat;
f) immediately stirring in ⅔ cup of lemon juice per quart of water;
g) allowing the mixture of water, sugar and lemon juice to cool to approximately 72 degrees Fahrenheit;
h) pouring a first portion of the mixture into a plastic second container;
i) covering the second container;
j) freezing the mixture.

It is therefore another aspect, advantage, objective and embodiment of the invention to provide a method of preparing an improved lemon ice confection further comprising:
f1) covering the first container immediately after stirring in ⅔ cup of lemon juice.

It is therefore another aspect, advantage, objective and embodiment of the invention to provide a method of preparing an improved lemon ice confection further comprising:
e1) prior to stirring in ⅔ cup of lemon juice, strain real lemon juice to remove lemon pulp therefrom.

It is therefore another aspect, advantage, objective and embodiment of the invention to provide a lemon ice confection made by the process of:
a) providing a first quantity of water in a first container;
b) providing a source of heat sufficient to boil the water;
c) adding to the water 2 cups of sugar per quart of water while continuing to boil the water;
d) continuing to boil the water until the sugar dissolves;
e) removing the source of heat;
f) immediately stirring in ⅔ cup of lemon juice;
g) allowing the mixture of water, sugar and lemon juice to cool to approximately 72 degrees Fahrenheit;
h) pouring a first portion of the mixture into a plastic second container;
i) covering the second container;
j) freezing the mixture.

### BRIEF DESCRIPTION OF THE DRAWINGS

FIG. 1 is a perspective view of a lemon ice confection according to a first embodiment of the invention.

FIG. 2 is a flow chart of a second embodiment of the invention as a method.

FIG. 3 is a flow chart of a third embodiment of the invention as a method.

FIG. 4 is a cross sectional view of a container of the invention, showing that the irregular frozen mixture, while containing no particulate matter, nonetheless has a different texture and appearance than a solid frozen block of water.

### INDEX OF REFERENCE NUMERALS

| | | |
|---|---|---|
| Single serving container/second container | | 100 |
| Confection | | 102 |
| Irregular frozen texture | | 104 |
| Add water to first container | step | 202 |
| Add heat to boil | step | 204 |
| Add sugar | step | 206 |
| Dissolve sugar | step | 208 |
| Remove heat | step | 210 |
| Immediately stir in lemon juice | step | 212 |
| Cool to room temperature | step | 214 |
| Pour into second container | step | 216 |
| Cover second container | step | 218 |
| Freeze | step | 220 |
| Add water to first container | step | 302 |
| Add heat to boil | step | 304 |
| Add sugar | step | 306 |
| Dissolve sugar | step | 308 |
| Remove heat | step | 310 |
| Strain lemon juice to remove solids | step | 312 |
| and immediately stir in lemon juice | | |
| Immediately cover first container | step | 314 |
| Cool to room temperature | step | 316 |
| Pour into second container | step | 318 |
| Cover second container | step | 320 |
| Freeze | step | 322 |
| Texture | | 402 |

### DETAILED DESCRIPTION

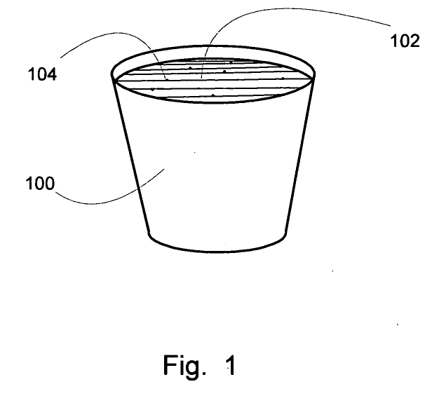

FIG. 1 is a perspective view of a lemon ice confection according to a first embodiment of the invention. Single serving container/second container 100 is similar to a cup of ice, however confection 102 is an irregular frozen texture 104. While it contains little or no particulate matter and no shaved ice or ice cream, the mixture is not as solid as frozen water.

Container 102 may be used in manufacturing: prior to freezing, the confection in the liquid state may be poured into container 102 and allowed to freeze therein. Container 102 may advantageously be a cup of paper or plastic, a wrapper of paper or plastic, and may have a cover or wrapper (not shown) which the end user may remove and discard.

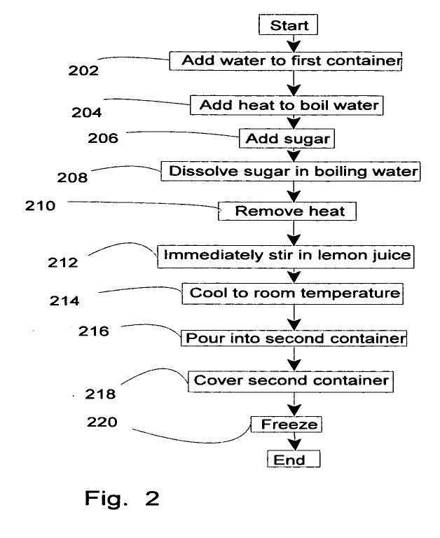

FIG. 2 is a flow chart of a second embodiment of the invention as a method. Water is added to a first container at step 202. First container 202 may be a commercial or industrial vessel of food grade such as a steam pot or the like, or it may be a smaller vessel such as a cooking pot.

Adding sufficient heat to boil the water (step 204) is believed necessary to ensure the dissolution and mixing of the later ingredients, however, it also provides a safety measure during manufacturing. Industrial steam vessels of course may conveniently provide a large amount of heat to a large amount of water quite quickly.

Step 206, addition of sugar, provides the sweet element of the taste of the final product. In presently preferred embodiments, 2 cups of sugar are added per quart of the water boiled, a proportion which may be scaled downwards or upwards as convenient. The added sugar is then dissolved by continuation of the boiling of the water (step 208) and the solution becomes an extremely sweet sugar water. Without wishing to be bound by any theory, it is believed that the irregular slightly softer texture of the final product is at least partially due to the inclusions of the sugar and lemon juice which alter the nature of the frozen products structure, resulting in water which is unable to freeze into a regular matrix.

After the sugar is dissolved, heat is removed (step 210) and the lemon juice is immediately stirred in (step 212).

Without wishing to be bound by any particular theory, it is believed that the removal from the boiling state and immediate addition of lemon juice prevents the more volatile fractions of the lemon juice from departing the water, resulting in a fresher flavor of the final product. It is believed that extensive handling of the liquid mixture after addition of the lemon juice aids the evaporation and removal of the more volatile components of the lemon juice, for example, experiments have shown that continued boiling after addition of the lemon juice causes loss of lemon juice freshness. It is also believed that allowing the liquid mixture to cool substantially prior to addition of the lemon juice may prevent adequate mixing, or may limit any reactions of sugar and lemon juice, and thus immediate addition of lemon juice after removal of the heat is desired in the best modes now contemplated.

The product is first allowed to cool to room temperature (step 214) and then it is poured into a second container such as container 100 (step 216). The second container is covered (step 218) and frozen (step 220) to make the final product.

While lemon ice creams and frozen lemonade products have been known, the product made by this process has a unique tangy flavor and a texture of the ice which is not similar to either a normally frozen water based beverage nor like an ice cream or sherbet.

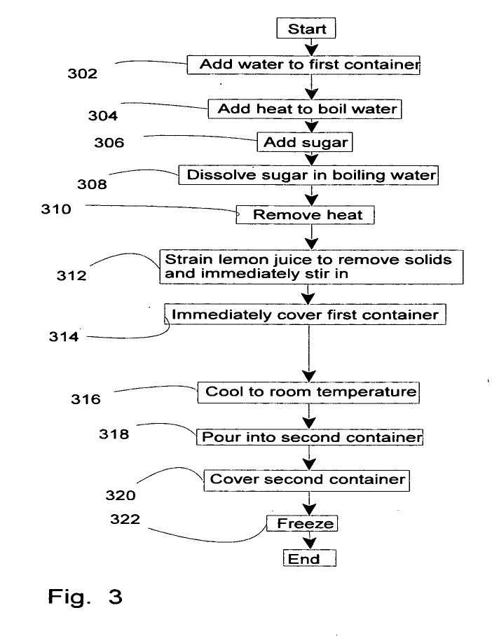

FIG. 3 is a flow chart of a third embodiment of the invention as a method. Adding water to the first container (step 302), adding heat to boil the water (step 304), adding sugar (step 306) and dissolving sugar (step 308) may be much as previously described in reference to the embodiment of FIG. 2.

In the presently preferred embodiment and best mode presently contemplated for carrying out the invention, after removal from heat at step 310, a lemon juice of different character from the previous embodiment is used. In particular, the lemon juice used is strained so as to remove solids such as pulp and the like, thus producing a “smoother” lemon juice. (This does not substantially alter the final product's unique texture.) Thus step 310, “strain lemon juice to remove solids” is added, however, this step may be advantageously carried out prior to any of the other steps 302 through 310, or simultaneously therewith.

In the presently preferred embodiment and best mode presently contemplated for carrying out the invention, the step 312 of stirring in the lemon juice immediately is followed by step 314, immediate covering of the first container. Without wishing to be bound by any particular theory, it is believed that restricting or reducing free removal of evaporated products raises the partial pressure of the more volatile components of the lemon juice, thus further retaining savor of the lemon juice. This step may be used in conjunction with the immediate addition of the lemon juice after heat removal discussed previously with respect to FIG. 2.

Cooling to room temperature at step 316, pouring into second container (step 318) and covering (step 320) and freezing (step 322) may be much as previously described with reference to FIG. 2.

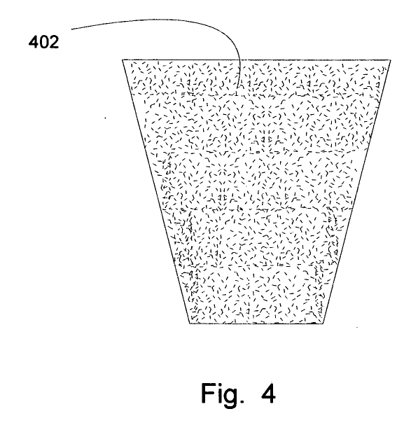

FIG. 4 is a cross sectional view of a container of the invention, showing that the irregular frozen mixture, while containing no particulate matter, nonetheless has a different texture and appearance than a solid frozen block of water.

Texture 404 is solid and substantially particulate free (sugar and/or lemon juice in solution may nucleate into small particles), unlike for example ice cream, which is normally a complex mixture of oils or a matrix of particles of the ice cream. However, the texture of the product of the process of the invention is unlike solid ice, and is not subject to forming a single solid phase during the freezing step.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of preparing an improved lemon ice confection, the method comprising the steps of:
a) providing a first quantity of water in a first container;
b) providing a source of heat sufficient to boil the water;
c) adding to the water 2 cups of sugar per quart of water while continuing to boil the water;
d) continuing to boil the water until the sugar dissolves;
e) removing the source of heat;
f) immediately stirring in ⅔ cup of lemon juice per quart of water;
g) allowing the mixture of water, sugar and lemon juice to cool to approximately 72 degrees Fahrenheit;
h) pouring a first portion of the mixture into a plastic second container;
i) covering the second container;
j) freezing the mixture.

2. The method of preparing an improved lemon ice confection of claim 1, further comprising:
f1) covering the first container immediately after stirring in ⅔ cup of lemon juice.

3. The method of preparing an improved lemon ice confection of claim 1, further comprising:
e1) prior to stirring in ⅔ cup of lemon juice, strain real lemon juice to remove lemon pulp therefrom.

4. The lemon ice confection made by the process of claim 1.
